(19) United States
(12) Patent Application Publication
(10) Pub. No.: US 2017/0056910 A1
(43) Pub. Date: Mar. 2, 2017

(54) Butterfly Scraper/Mil Gauge Paint Sprayer Attachment

(71) Applicant: Ernesto Guzman, Blaine, MN (US)

(72) Inventor: Ernesto Guzman, Blaine, MN (US)

(21) Appl. No.: 15/251,584

(22) Filed: Aug. 30, 2016

Related U.S. Application Data
(60) Provisional application No. 62/213,013, filed on Sep. 1, 2015.

(51) Int. Cl. B05B 15/00; B44D 3/16; B05B 12/08

(52) U.S. Cl. CPC B05B 15/001; B05B 12/084; B44D 3/162

(57) ABSTRACT

The invention is a tip guard with a removably attachable scraper and/or mil gauge.

### CROSS-REFERENCE TO RELATED APPLICATIONS

This application claims priority to provisional patent application no. 62/213013 filed Sept. 1, 2015, the entire contents of which are hereby incorporated by reference.

### STATEMENT REGARDING FEDERALLY SPONSORED RESEARCH

Not Applicable

### FIELD OF THE INVENTION

The invention relates to a sprayer tip guard commonly referred to as a butterfly, with one or two attachments, namely a scraper and a wet film thickness gauge.

### BACKGROUND OF THE INVENTION

Painters have to use a scraper hundreds of times per day and have to frequently measure the thickness of the coating being applied with a mil gauge to ensure that the job is meeting the specifications. The mil gauge and scraper require the use of a different hand and can be dropped or easily lost.

What is needed is a way to allow for the easy use of a scraper and mil gauge so they are always at hand and not easily lost.

### BRIEF SUMMARY OF THE INVENTION

The invention accomplishes this by attaching a scraper and/or a mil gauge to the butterfly, which is also called a sprayer tip guard. Each attachment is clamped or fastened to one wing of the tip guard.

The attachments can be made of plastic or metal, or a combination thereof

The butterfly and attachments could also be made from a single piece of metal or plastic.

### BRIEF DESCRIPTION OF THE DRAWINGS

FIG. 1 is a perspective view showing the inventive butterfly with both the scraper attachment and the wet film thickness gauge attachment.

FIG. 2 is a perspective view showing the other side of FIG. 1.

FIG. 3 shows a prior art butterfly (tip guard) with the parts of each attachment.

FIG. 4 is shows the mil gauge partially assembled.

FIG. 5 is shows the mil gauge fully assembled.

FIG. 6 is shows the scraper partially assembled.

FIG. 7 shows a rotatable mil gauge attachment.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

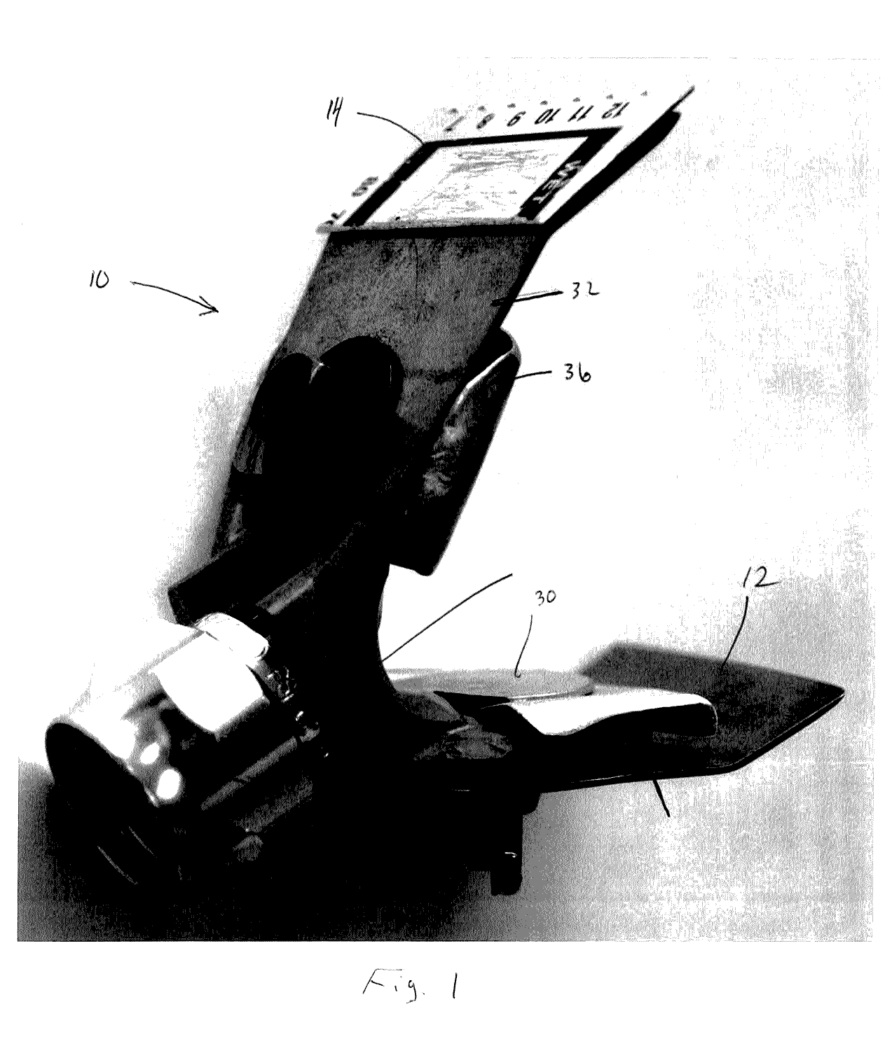

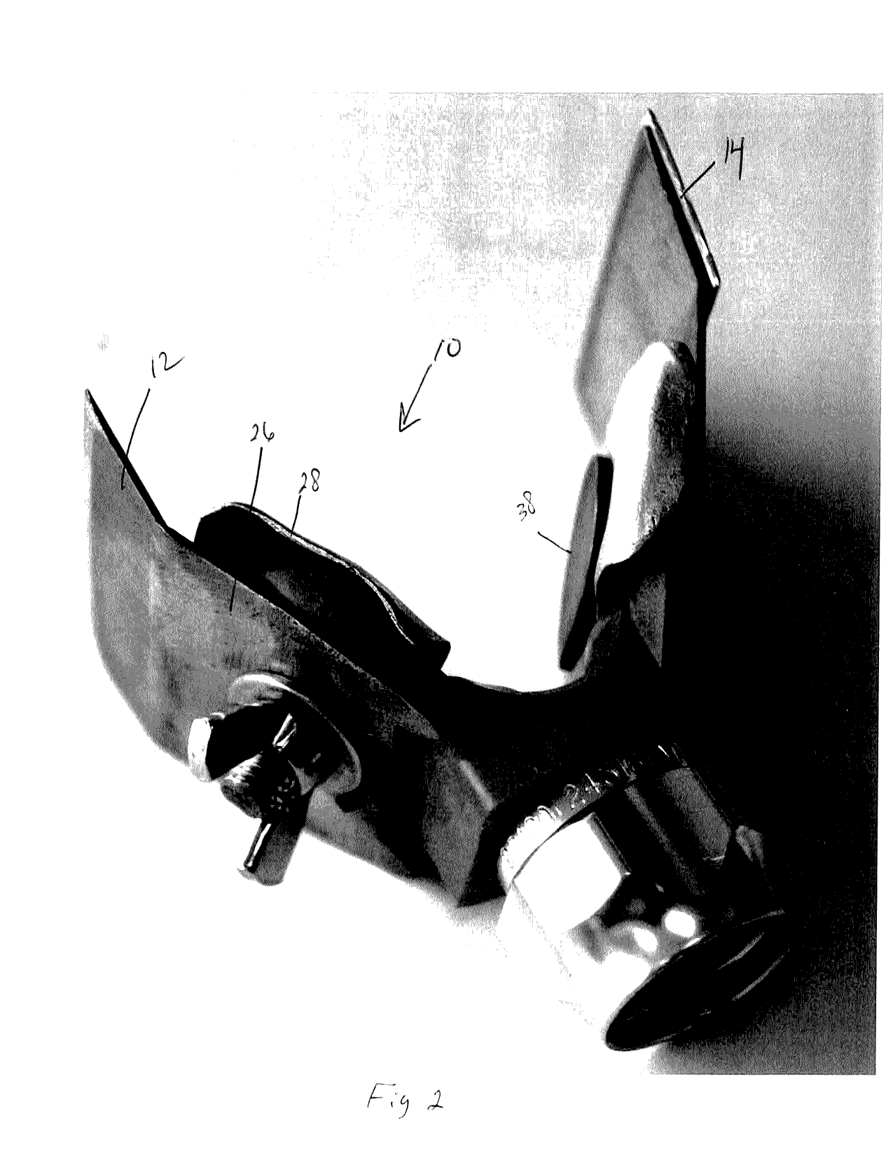

FIGS. 1 and 2 show a perspective view of a prototype of the invention. A butterfly or sprayer tip guard is shown generally at 10. The tip guard has a scraper attachment shown at 12 and a wet film thickness gauge attachment shown at 14 (referred to as a mil gauge).

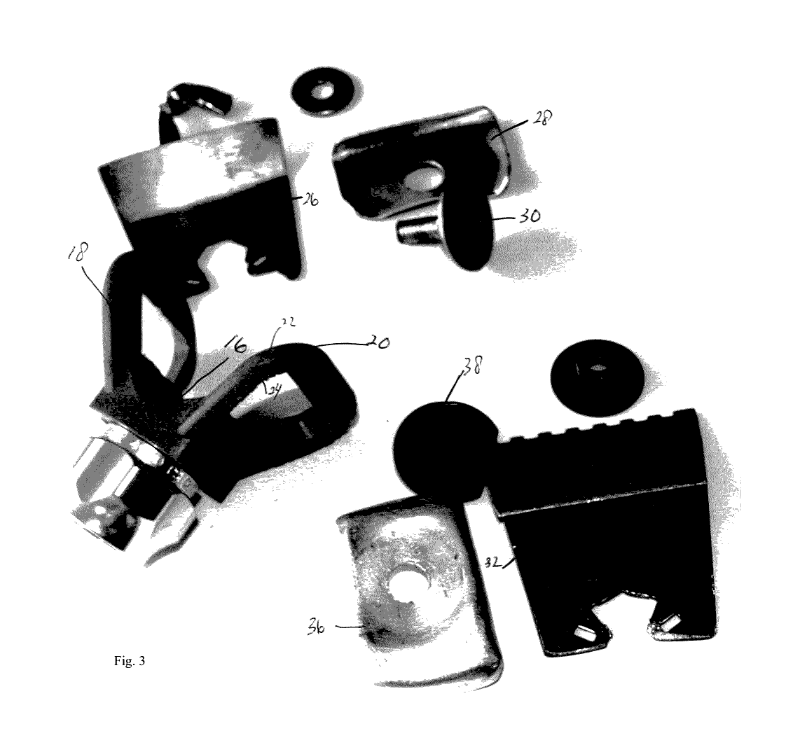

FIG. 3 shows a prior art butterfly or tip guard, which has a base portion 16, with opposing protruding portions or wings 18 and 20. Each wing has an inside surface 22 and an outside surface 24.

In FIGS. 1 and 2, each attachment is clamped to its respective wing by two parts mechanically fastened together. The scraper 12 has a plate 26 positioned on the outside surface of a wing, and a plate 28 positioned on the inside surface of a wing, clamped together by a bolt 30. The mil gauge attachment 14 has a plate 32 positioned on the outside surface of a wing, and a plate 36 positioned on the inside surface of a wing, clamped together by a bolt 38. The inside plates can be any size, as long as they permit the inside and outside plates to clamp together to secure the attachment to a wing.

The attachments can be made of any metal or any plastic material, or a mixture of each. The butterfly and the attachments could also be made of a single piece of metal or plastic, molded, cast or even cut from a block of material.

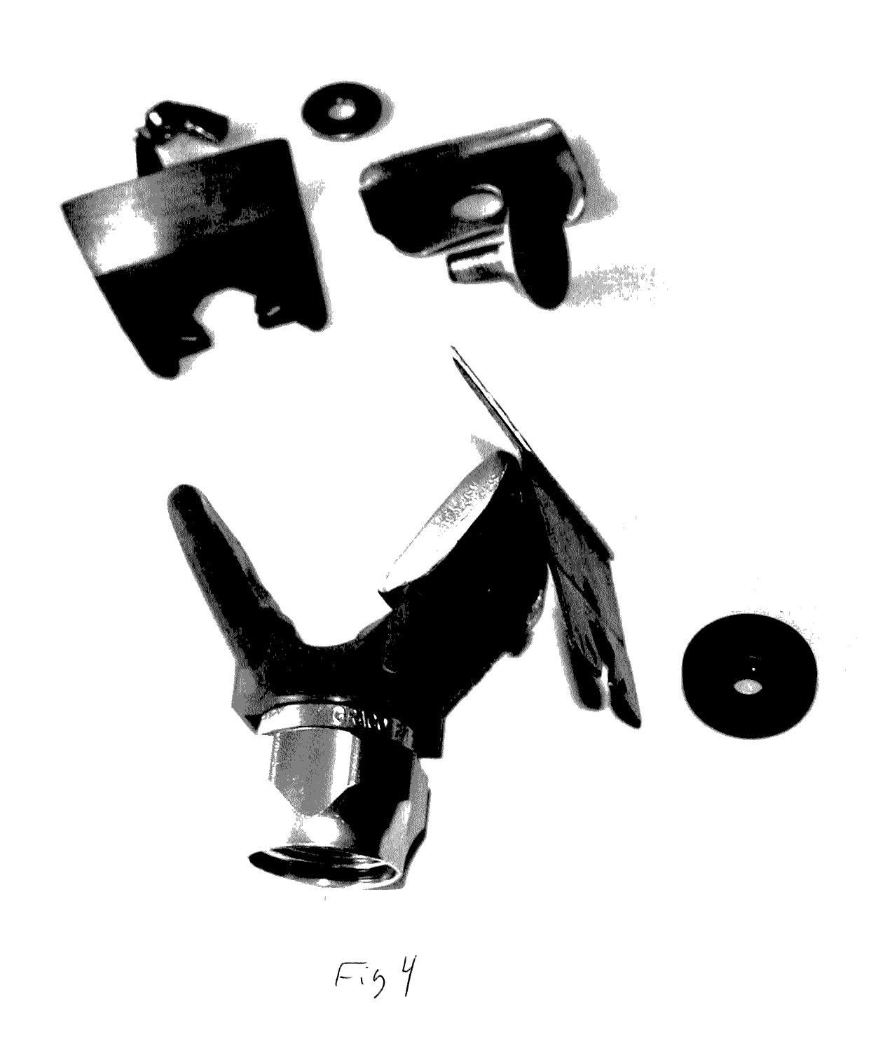

FIG. 4 shows the invention with the mil gauge inner plate and screw attached and the outside plate ready for attachment.

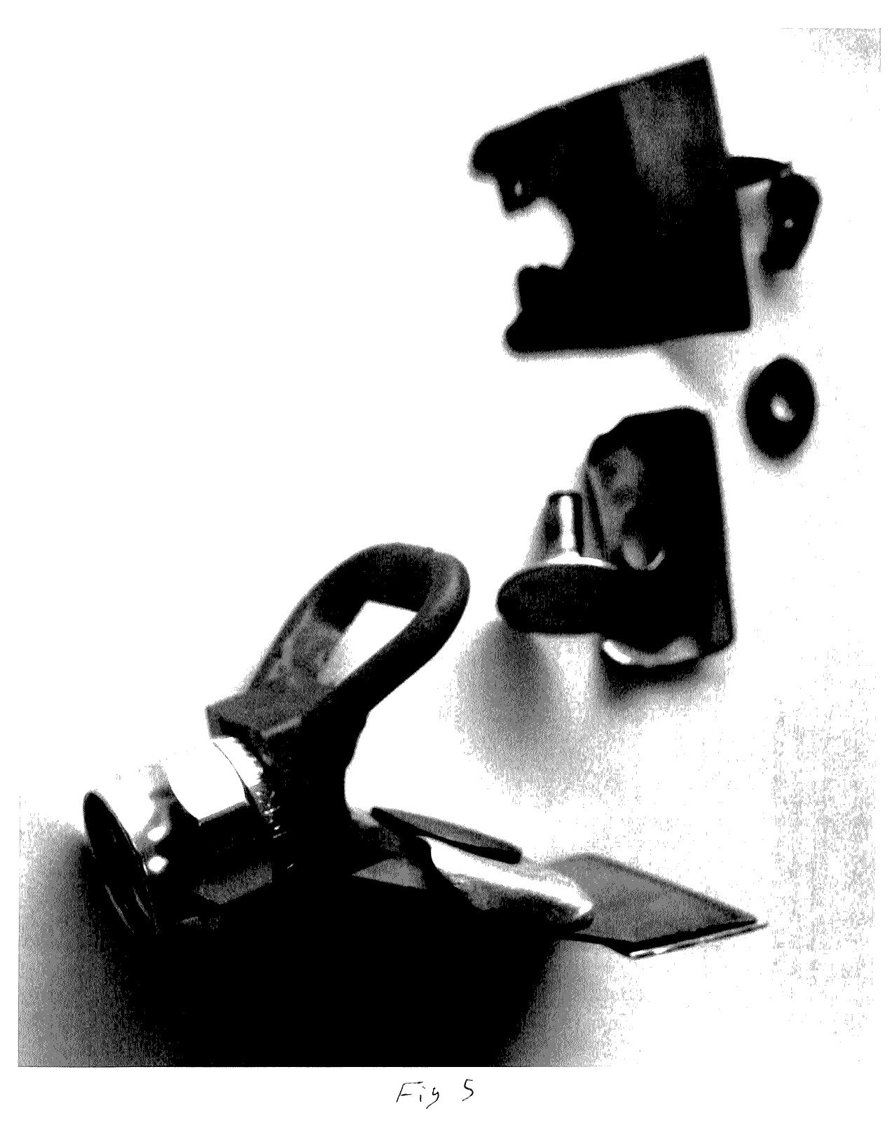

FIG. 5 shows the mil gauge fully assembled and clamped to a wing of the butterfly.

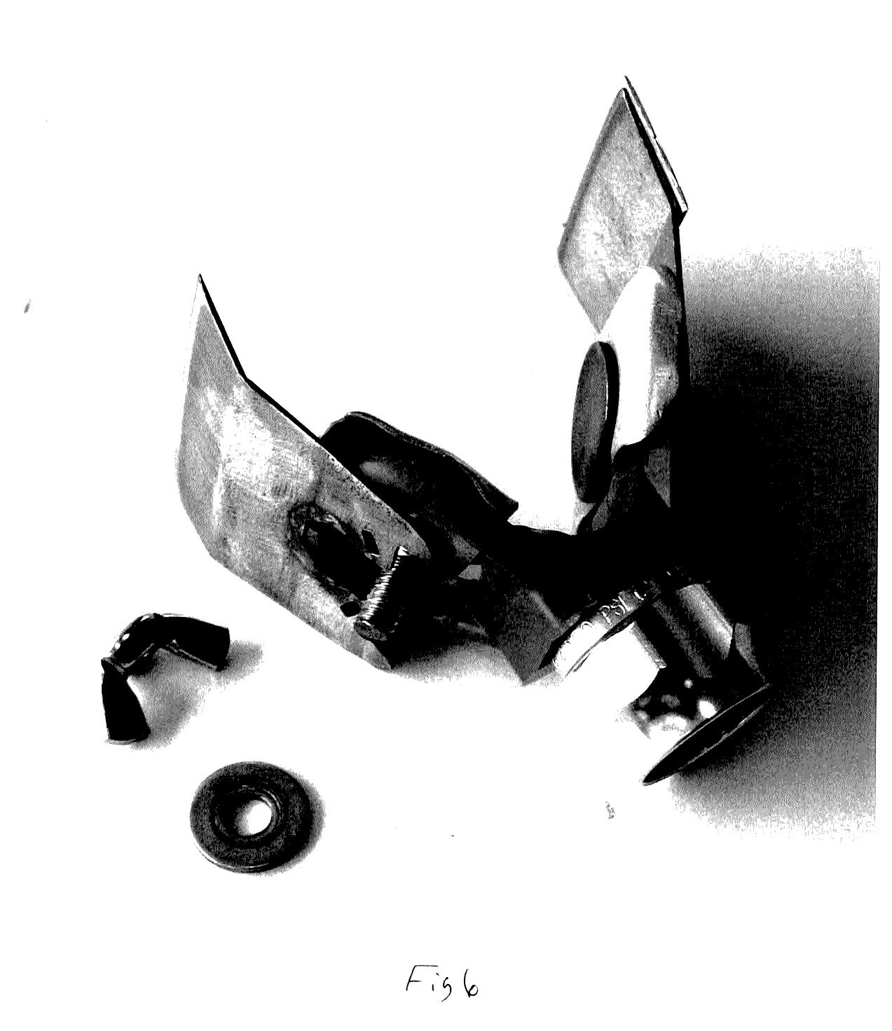

FIG. 6 shows the scraper with the inner plate and screw attached and the outside plate ready for attachment.

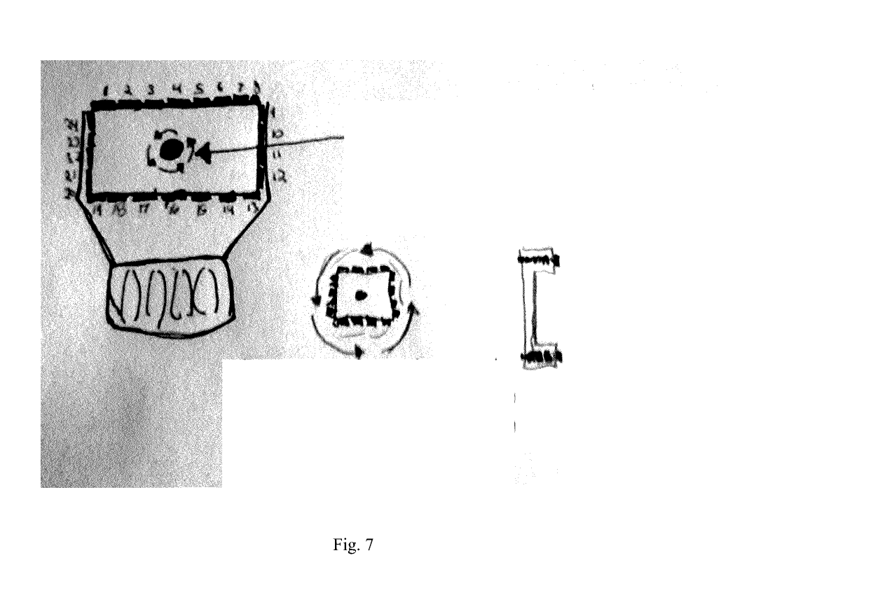

FIG. 7 shows a mil gauge attachment with differing depths arranged around the perimeter of the gauge, and which is rotatably attached so that the gauge can be rotated until the proper side is facing up.

It should also be understood that the attachments could be also be one piece and fasten to the wing itself, rather than clamping two parts together.

It should also be understood that the mil gauge can have the depth markings engraved, painted or both.

1. A spray painter tip guard of the type having two side portions, the improvement comprising:
attaching a scraper to one of the two side portions.

2. The spray painter tip guard of claim 1 further including attaching a wet film thickness gauge to the other of the two side portions.

3. The spray painter tip guard of claim 2 wherein the tip guard, scraper and wet film thickness gauge are each made of a metal.

4. The spray painter tip guard of claim 1 wherein the scraper is removably attached.

5. The spray painter tip guard of claim 2 wherein the wet film thickness gauge is removably attached.

6. The spray painter tip guard of claim 1 wherein each side portion has an inside portion and an outside portion and the scraper has a first portion and a second portion, the first portion of the scraper being on the inside portion and the second portion being on the outside portion, the first portion and the second portion being attached to each other.

7. The spray painter tip guard of claim 6 wherein the first portion and the second portion are attached to each other by being integrally formed.

8. A spray painter tip guard of the type having two side portions, the improvement comprising:
attaching a wet film thickness gauge to one of the two side portions.

9. The spray painter tip guard of claim 8 further including attaching a scraper to the other of the two side portions.

10. The spray painter tip guard of claim 9 wherein the tip guard, scraper and wet film thickness gauge are each made of a metal.

11. The spray painter tip guard of claim 8 wherein the wet film thickness gauge is removably attached.

12. The spray painter tip guard of claim 9 wherein the scraper is removably attached.

13. The spray painter tip guard of claim 8 wherein each side portion has an inside portion and an outside portion and the scraper has a first portion and a second portion, the first portion of the scraper being on the inside portion and the second portion being on the outside portion, the first portion and the second portion being attached to each other.

14. The spray painter tip guard of claim 13 wherein the first portion and the second portion are attached to each other by being integrally formed.

15. A spray painter tip guard comprising:
a base having opposing sides and having a spray tip opening;
a first guard protrusion extending from one side of the base;
a second guard protrusion extending from the other side of the base;
a scraper attached to the first guard protrusion, and
a wet film thickness gauge attached to the second guard protrusion.

16. The spray painter tip guard of claim 15 wherein the base, guard protrusions, scraper and wet film thickness gauge are all formed integrally.

17. The spray painter tip guard of claim 15 wherein the scraper is mechanically attached to the first guard protrusion.

18. The spray painter tip guard of claim 15 wherein the wet film thickness gauge is mechanically attached to the second guard protrusion.

19. The spray painter tip guard of claim 16 wherein the base, guard protrusions, scraper and web film thickness gauge are all formed integrally of a single piece of metal.

20. The spray painter tip guard of claim 16 wherein the base, guard protrusions, scraper and web film thickness gauge are all formed integrally of a single piece of plastic.

21. The spray painter tip guard of claim 15 wherein the scraper and wet film thickness gauge are formed of plastic.

22. The spray painter tip guard of claim 18 wherein the wet film thickness gauge has depth markings which are engraved, painted or both engraved and painted.

23. The spray painter tip guard of claim 15 wherein the wet film thickness gauge is rotatably attached.
